(19) United States
(12) Patent Application Publication
(10) Pub. No.: US 2026/0313600 A1
(43) Pub. Date: Oct. 8, 2026

(54) Method and Apparatus for Prioritizing Different UWB Sessions

(71) Applicant: Bayerische Motoren Werke Aktiengesellschaft, Muenchen (DE)

(72) Inventor: Daniel KUELZER, Muenchen (DE)

(21) Appl. No.: 19/638,276

(22) Filed: Apr. 3, 2026

(30) Foreign Application Priority Data
Apr. 4, 2025 (DE) 102025113309.3

(51) Int. Cl. H04W 64/00; H04B 1/7163; H04W 56/00

(52) U.S. Cl. CPC H04W 64/00; H04B 1/7163; H04W 56/0015

(57) ABSTRACT

An apparatus for prioritizing a set of different UWB sessions for performing UWB ranging procedures for a corresponding set of different devices in and/or on a vehicle is described. The apparatus is configured to determine that there is a conflict between the set of different UWB sessions for a particular time interval. The apparatus is further configured to prioritize the different UWB sessions of the set of UWB sessions in relation to the conflict based on one or more prioritization criteria.

### CROSS REFERENCE TO RELATED APPLICATION

This application claims priority under 35 U.S.C. §119 from German Patent Application No. 10 2025 113 309.3, filed Apr. 4, 2025, the entire disclosure of which is herein expressly incorporated by reference.

### BACKGROUND AND SUMMARY

The invention relates to a method and a corresponding apparatus for prioritizing UWB sessions for locating different electronic devices in and/or on a (motor) vehicle.

A vehicle may have one or more functions that can be remotely controlled by a user of the vehicle using an electronic device, such as a smartphone. An example of a vehicle function is the unlocking and/or locking or the opening and/or closing of a door or flap of the vehicle and/or the execution of an automated parking operation and/or the adjustment of a vehicle seat. The one or more vehicle functions are typically remotely controlled via a wireless communication connection, in particular via a BLE communication connection, between the vehicle and the electronic device.

As part of the (remote) control of a vehicle function, the electronic device can be located on the basis of a UWB session, in particular on the basis of a UWB ranging procedure carried out within a UWB session. In this case, it may happen that a plurality of electronic devices, each of which is authorized to (remotely) control a vehicle function, are arranged in and/or on the vehicle.

The present document deals with the technical object of locating a plurality of electronic devices in and/or on a (motor) vehicle in a particularly robust manner, in particular in order to enable reliable remote control (in time) of one or more vehicle functions by a plurality of electronic devices.

The object is achieved by each of the independent claims. Advantageous embodiments are described inter alia in the dependent claims. It is pointed out that additional features of a patent claim dependent on an independent patent claim, without the features of the independent patent claim or in combination only with a subset of the features of the independent patent claim, may form a standalone invention that is independent of the combination of all of the features of the independent patent claim and may be made into the subject matter of an independent claim, a divisional application or a subsequent application. This applies in the same way to technical teachings that are described in the description and may form an invention independent of the features of the independent patent claims.

One aspect describes an apparatus for prioritizing a set of different UWB sessions for performing UWB ranging procedures for a corresponding set of different (electronic) devices in and/or on a (motor) vehicle. The individual devices can each have a digital key, in particular a digital key designed in accordance with the Car Connectivity Consortium (CCC) standard, for example, release 3 or higher or release 4 or higher. The individual devices can each be designed to remotely control (using the digital key) one or more vehicle functions of the vehicle. For this purpose, a Bluetooth Low Energy (BLE) communication connection can exist in each case between the vehicle and the individual devices. The UWB sessions of the individual devices can each have been activated or set up via the respective BLE communication connection. The UWB sessions may each have been activated or set up according to the method specified in the CCC standard TS-101 (in particular release 4 or higher). Details of this (and details of the UWB ranging procedure) are described in particular in chapters 19, 20 and 21. These are fully incorporated by reference in the present document.

During a UWB session, a UWB packet, in particular a pre-poll packet or a poll packet, can be sent from a device to the vehicle in order to perform a UWB ranging procedure. The vehicle can respond to this with a further UWB packet, in particular with a response packet. The distance between the device and the vehicle can be determined on the basis of the interchanged UWB packets, in particular on the basis of the time of flight of the UWB packets.

The apparatus can be configured to receive a UWB packet, in particular a pre-poll packet, in a particular time interval and/or to send a UWB packet, in particular a response packet, in the particular time interval in order to perform a UWB ranging procedure within a UWB session. The UWB ranging procedure can be repeated regularly within the respective UWB session in order to effect an updated determination of the distance between the device and the vehicle.

The UWB resource of the vehicle required for performing UWB ranging procedures can typically be used only in each case exactly for one UWB session and/or for exactly one UWB ranging procedure in a particular time interval. If a plurality of UWB sessions exist, there may therefore be a conflict surrounding the UWB resource between a plurality of UWB sessions in a particular time interval.

The apparatus is configured to determine that there is a conflict between the set of different UWB sessions for a particular time interval. In particular, it is possible to determine that there is a conflict surrounding the UWB resource of the vehicle between the set of different UWB sessions for the particular time interval. The set of different UWB sessions may comprise N different UWB sessions for N different devices, with N≥2.

The apparatus is further configured to prioritize the different UWB sessions of the set of UWB sessions in relation to the conflict (surrounding the UWB resource) on the basis of one or more prioritization criteria. In particular, the apparatus can be configured to determine a prioritized UWB session from the set of UWB sessions on the basis of the one or more prioritization criteria. The UWB resource may then be assigned (exclusively) to the prioritized UWB session in the particular time interval.

The one or more prioritization criteria may depend on the function priority of a remote-controlled vehicle function of the vehicle, for which a UWB session from the set of UWB sessions is used. As already explained, it may be made possible for a device to remotely control one or more vehicle functions. In this case, a function priority may have been defined for one or more (safety-relevant) vehicle functions (for example for remote control of the longitudinal and/or lateral guidance of the vehicle) in order to enable particularly reliable remote control of these one or more vehicle functions. This vehicle function can be performed in a particularly reliable manner by giving preference to a UWB session which is used for the remote control of a prioritized vehicle function.

The apparatus may be configured to identify a first UWB session from the set of UWB sessions that is used for the remote control of a vehicle function having a particular function priority. The apparatus may further be configured to prioritize the first UWB session in relation to the conflict (surrounding the UWB resource) over one or more other UWB sessions from the set of UWB sessions.

The first UWB session can possibly be prioritized only when the first UWB session has temporal synchronization. In particular, the apparatus can be configured to determine the state of the temporal synchronization of the first UWB session. The first UWB session may then be prioritized (or not prioritized) in relation to the conflict (surrounding the UWB resource) over the one or more other UWB sessions from the set of UWB sessions on the basis of the determined state of the temporal synchronization of the first UWB session. This makes it possible to bring about a particularly optimized and robust compromise with regard to the remote control of vehicle functions by different devices.

In particular, the apparatus can be configured to determine, as a state of the temporal synchronization of the first UWB session, whether the first UWB session has the fallback state in which there is no temporal synchronization of the first UWB session, or has the BLE time sync state or the UWB time sync state in which there is in each case temporal synchronization of the first UWB session. The first UWB session may be prioritized in relation to the conflict (surrounding the UWB resource) over the one or more other UWB sessions from the set of UWB sessions when the first UWB session is in the BLE time sync state or in the UWB time sync state. On the other hand, the first UWB session is preferably not prioritized in relation to the conflict (surrounding the UWB resource) over the one or more other UWB sessions from the set of UWB sessions when the first UWB session is in the fallback state.

Alternatively or additionally, the one or more prioritization criteria can thus depend on the state of the temporal synchronization of the different UWB sessions of the set of UWB sessions.

In particular, the apparatus can be configured to determine for each of the individual UWB sessions of the set of UWB sessions whether the respective UWB session has the fallback state in which there is no temporal synchronization of the respective UWB session, or has the BLE time sync state or the UWB time sync state in which there is temporal synchronization of the respective UWB session in each case. Furthermore, the apparatus may be configured to prioritize a UWB session having the BLE time sync state or the UWB time sync state in relation to the conflict (surrounding the UWB resource) over a UWB session having the fallback state.

A UWB session may possibly be in one of three states with respect to the temporal synchronization, in particular the fallback state, the BLE time sync state or the UWB time sync state. A UWB session may change (possibly automatically) from the fallback state or from the BLE time sync state to the UWB time sync state in response to receiving a UWB packet. The temporal synchronization in the UWB time sync state typically has a higher statistical accuracy than in the BLE time sync state.

The apparatus may be configured to prioritize a UWB session having the UWB time sync state in relation to the conflict (surrounding the UWB resource) over a UWB session having the BLE time sync state.

By taking into account the state of the temporal synchronization in the prioritization of the different UWB sessions, it is possible to bring about an optimized and robust compromise with regard to the remote control of vehicle functions by different devices.

Alternatively or additionally, the one or more prioritization criteria may depend on the reception time windows for receiving a UWB packet from one or more UWB sessions of the set of UWB sessions. In particular, the apparatus can be configured to determine a time window for receiving a UWB packet within the respective UWB session for at least two UWB sessions from the set of UWB sessions, in particular for at least two UWB sessions, in each of which there is temporal synchronization of the respective UWB session. One of the two UWB sessions can then be prioritized in relation to the conflict (surrounding the UWB resource) over the respective other UWB session on the basis of the determined time windows, in particular on the basis of the start times of the determined time windows.

By taking into account the reception time windows of the different UWB sessions in the prioritization of the different UWB sessions, it is possible to bring about an optimized and robust compromise with regard to the remote control of vehicle functions by different devices.

The apparatus can be configured sequentially:

to check whether a prioritized UWB session can be identified on the basis of the prioritization criterion that depends on a function priority of a remote-controlled vehicle function of the vehicle; and

if not, to check whether a prioritized UWB session can be identified on the basis of the prioritization criterion that depends on the state of the temporal synchronization of the different UWB sessions; and

if not, to check whether a prioritized UWB session can be identified on the basis of the prioritization criterion that depends on the reception time windows for receiving a UWB packet from one or more UWB sessions.

Such a sequential check of the prioritization criteria makes it possible to bring about a particularly optimized and robust compromise with regard to the remote control of vehicle functions by different devices.

The apparatus can be configured, if no UWB session can be prioritized on the basis of the one or more prioritization criteria, in particular because there is no temporal synchronization for any of the UWB sessions from the set of UWB sessions, to identify the temporally first UWB packet received within the particular time interval, and to determine the UWB session from the set of UWB sessions within which the identified UWB packet was sent. The determined UWB session can then be prioritized in relation to the conflict (surrounding the UWB resource) over the one or more other UWB sessions from the set of UWB sessions. This makes it possible to bring about particularly robust remote control of vehicle functions by different devices.

Another aspect describes a (road) motor vehicle (in particular a passenger vehicle or a commercial vehicle or a bus or a motorcycle) that comprises the apparatus described in this document.

Another aspect describes a method for prioritizing a set of different UWB sessions for performing UWB ranging procedures for a corresponding set of different (electronic key) devices in and/or on a (motor) vehicle. The method comprises determining that there is a conflict between the set of different UWB sessions for a particular time interval. Furthermore, the method comprises prioritizing the different UWB sessions of the set of UWB sessions in relation to the conflict on the basis of one or more prioritization criteria. The one or more prioritization criteria may depend on:

the function priority of a remote-controlled vehicle function of the vehicle, for which a UWB session from the set of UWB sessions is used;

the state of the temporal synchronization of the different UWB sessions of the set of UWB sessions; and/or

the reception time windows for receiving a UWB packet from one or more UWB sessions of the set of UWB sessions.

It should be noted that the aspects described in connection with the apparatus, in particular the claims described in connection with the apparatus, can also be applied as corresponding method features to the method.

Another aspect describes a software (SW) program. The SW program can be configured to be executed on a processor and to thereby carry out the method described in this document.

Another aspect describes a non-transitory storage medium. The storage medium may comprise an SW program that is configured to be executed on a processor and thereby to carry out the method described in this document.

It should be noted that the methods, apparatuses and systems described in this document may be used both on their own and in combination with other methods, apparatuses and systems described in this document. Furthermore, any aspects of the methods, apparatuses and systems described in this document may be combined with one another in a wide variety of ways. The features of the claims may in particular be combined with one another in a wide variety of ways. Furthermore, features in parentheses should be understood as optional features.

The invention is described in more detail below with reference to exemplary embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1a shows an exemplary digital entry system of a vehicle;

FIG. 1b shows an exemplary usage situation for a digital entry system;

FIG. 2a shows exemplary messages between a vehicle and a digital key device;

FIG. 2b shows an exemplary state machine for a UWB session for locating an electronic device; and

FIG. 3 shows a flowchart of an exemplary method for prioritizing UWB sessions of a set of electronic devices.

### DETAILED DESCRIPTION OF THE DRAWINGS

As set out at the outset, the present document deals with the robust localization of a plurality of different electronic devices, in particular in order to be able to remotely control one or more vehicle functions of a vehicle in a reliable manner using the electronic devices.

FIG. 1a shows an exemplary (entry) system 150 comprising at least one vehicle 100 and one or more electronic devices 110, in particular one or more digital key devices. A digital key device 110 is typically a portable electronic device, for example, a smartphone or a tablet PC, wherein a digital key 111 is stored on the portable electronic device. The digital key 111 may be stored in a protected memory area, in particular in a so-called "secure element", of the portable electronic device (such as the user device).

The digital key device 110 is designed to communicate with a communication unit 102 of the vehicle 100 over one or more different wireless communication connections 112. The different communication connections 112 can be used for different purposes. In particular, a Bluetooth Low Energy (BLE) communication connection 112 can be used to:

determine the distance and/or relative position between the digital key device 110 and the vehicle 100 (in particular on the basis of the signal strength, in particular the RSSI (Received Signal Strength Indicator), of the radio signals interchanged between the vehicle 100 and the device 110; and/or using BLE channel sounding (mode 2/phase-based measurements)); and/or

interchange data between the digital key device 110 and the vehicle 100 (for example, a control command for controlling a vehicle function 103, such as the unlocking of a door and/or the opening or closing of a window and/or the activation or deactivation of a heating function and/or the activation or deactivation of the drive motor of the vehicle 100).

Alternatively or additionally, an ultra-wideband (UWB) communication connection 112 may be used to determine the position of the device 110 relative to the vehicle 100 with a relatively high degree of accuracy. Determining the position of the device 110 using the UWB communication connection 112 may be referred to as UWB ranging.

A (control) apparatus 101 of the vehicle 100 may be designed to control at least one vehicle function 103 of the vehicle 100 on the basis of the communication between the device 110 and the vehicle 100, as illustrated in FIG. 1b for example. In this context, the digital key 111 of the device 110 can be verified, in particular authenticated. Furthermore, after successful authentication, one or more vehicle functions 103 can be controlled, in particular on the basis of:

the distance between the device 110 and the vehicle 100;

the position of the device 110 relative to the vehicle 100; and/or

a control command that is sent from the device 110 to the vehicle 100 over a communication connection 112.

In an exemplary system 150, a BLE communication connection 112 can be established between the device 110 and the vehicle 100 as soon as the distance between the device 110 and the vehicle 100 is equal to or less than a first distance threshold value 121. This allows the user to remotely control one or more vehicle functions 103 using the device 110. Typically, the vehicle 100 repeatedly indicates, e.g., at a specific frequency, the availability of a BLE communication connection 112. From the first distance threshold value 121, the device 110 (which may also be referred to as "user equipment" (UE)) receives the indicator message from the vehicle 100 and the BLE communication connection 112 can then be established between the device 110 and the vehicle 100. The first distance threshold value 121 may depend on the communication capabilities of the device 110, the environment of the vehicle 100 and/or of the device 110, and/or the position of the device 110 relative to the vehicle 100.

Furthermore, a UWB communication connection 112 may be established between the device 110 and the vehicle 100 as soon as the distance between the device 110 and the vehicle 100 is equal to or less than a second distance threshold value 122 (which may be less than the first distance threshold value 121 and/or which may depend on the communication capabilities of the device 110). Based on the UWB communication connection 112, the location of the device 110 may be determined with a relatively high degree of accuracy. One or more additional vehicle functions 103 can possibly be controlled via the UWB communication connection 112 (in addition to the one or more functions 103 which can be controlled via the BLE communication connection 112).

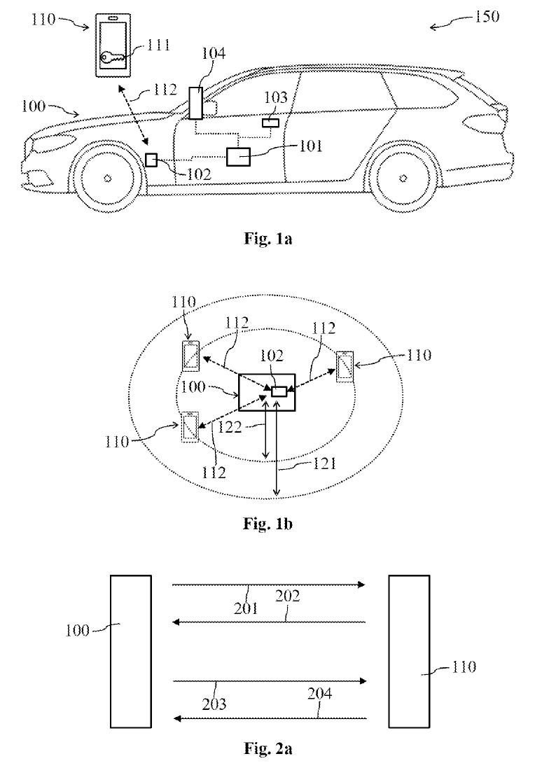

FIG. 2a illustrates the (possibly repeated, in particular periodic) sending of an indicator message 201 by the vehicle 100 in order to indicate that a (BLE) communication connection 112 to the vehicle 100 can be established. In this case, (if appropriate precisely) one indicator message 201 can be sent per advertisement interval. FIG. 2a further shows a response message 202 which is sent from the device 110 to the vehicle 100 in response to the receipt of an indicator message 201 in order to establish the communication connection 112. Following the establishment of the (BLE) communication connection 112, messages 203, 204 can be interchanged between the vehicle 100 and the device 110 via the communication connection 112, e.g., in order to remotely control a vehicle function 103.

In order to precisely locate a device 110, a UWB ranging session, a UWB session for short, can be performed. In this case, the device 110 may have the function of the initiator, and the vehicle 100 may have the function of the responder. Furthermore, the device 110 may have the function of the controller.

It can be agreed between the vehicle 100 and the device 110 that a UWB session (for locating the device 110) is performed. For this purpose, a message 203, for example a session request message or a session setup message, can be sent (in particular to the device 110), in particular from the vehicle 100, over the BLE communication connection 112. It is then possible to respond with a corresponding response message 204.

During a UWB session, the initiator can send a UWB packet, for example a pre-poll packet or a poll packet, to the responder. The responder may respond to this with a further UWB packet (e.g. with a response packet). The distance between the initiator and the responder can be determined on the basis of the ToF (Time of Flight) of the interchanged UWB packets. The initiator can inform the responder of the determined ToF via a further UWB packet (e.g. in a final packet).

For a UWB session, use is made of a time base which is typically set by the initiator. In particular, the time base of the initiator can be used as a time base for the UWB session. The time base defines a time pattern, in particular a MAC (Message Authentication Code) time pattern, for sending UWB packets. If the responder knows the time pattern of the UWB session, the responder can determine a time window for receiving a UWB packet. The receiver circuit of the responder then only has to be activated selectively for the determined time window, such that the energy consumption for locating a device 110 can be reduced.

The responder can be informed about the time base of the initiator during a synchronization method. The time synchronization between the vehicle 100 and the device 110 can be carried out on the basis of a BLE synchronization method. In particular, a BLE synchronization method can be performed directly when establishing the BLE communication connection 112 between the vehicle 100 and the device 110 in order to cause the vehicle 100 and the device 110 to have a common time base. Performing the BLE synchronization method when establishing the BLE communication connection 112 is typically referred to as "Procedure 0".

Furthermore, the vehicle 100 may be enabled to explicitly initiate time synchronization. The time synchronization can be initiated, for example, before a session request message and/or before a session setup message. The performance of the BLE synchronization method initiated by the vehicle 100 is typically referred to as “Procedure 1”.

If the time synchronization can be successfully performed according to the BLE synchronization method, the vehicle 100 and the device 110 are “in sync” in terms of time. This temporal synchronization can be referred to as "BLE_time sync". The pairing of the device 110 and the vehicle 100 is thus in the BLE time sync state. In this case, the temporal synchronization in the BLE time sync state has a specific temporal inaccuracy, for example, of ±1 ms or less, or of ±0.5 ms or less.

The quality of the temporal synchronization can typically be increased by receiving a UWB packet. In particular, the responder (i.e., the vehicle 100) may increase the accuracy with which its time base matches the time base of the initiator (i.e., the device 110) as soon as the responder has received a UWB packet (e.g., the pre-poll packet) from the initiator. This improved temporal synchronization following the receipt of a UWB packet can be referred to as UWB time sync. The pairing of the device 110 and the vehicle 100 is then in the UWB time sync state.

The vehicle 100 typically has a plurality of communication units 102 which may each have the function of a responder. Providing a plurality of (e.g., at least or exactly three) communication units 102 makes it possible to locate a device 110 in a particularly precise manner (e.g., by using a triangulation method). As soon as a responder of the vehicle 100 receives a UWB packet, the pairing of the device 110 and the vehicle 100 can be transferred to the UWB time sync state. The one or more further responders of the vehicle 100 can be informed about the time base via bus communication and, as a result thereof, have a uniform and/or identical time base among one another.

If the responder has no knowledge of the time base of the initiator (e.g., because the performance of the BLE synchronization method failed), the pairing of the device 110 and the vehicle 100 may be in a fallback state. Since the responder in this case has no knowledge of the time pattern of the UWB session, the receiver circuit of the responder is typically permanently active in order to receive the initial UWB packet (e.g., the pre-poll packet) for performing a UWB ranging procedure when the device-vehicle pairing of the UWB session is in the fallback state.

FIG. 2b shows a state diagram 210 with different states with regard to the UWB-based localization of the device 110 in a device-vehicle pairing relative to the vehicle 100 in the device-vehicle pairing. The state diagram 210 distinguishes between an inactive UWB session 222 and an active UWB session 221. As described further above, a UWB session for locating the device 110 in the device-vehicle pairing relative to the vehicle 100 in the device-vehicle pairing can be activated (e.g., by a session setup message) via the existing BLE communication connection 112 between the device 110 and the vehicle 100 in the device-vehicle pairing. As a result, a transition from state 222 to an active UWB session 221 may be effected (transitions 234, 235).

Within the active UWB session 221, different states 211, 212, 213 of the device-vehicle pairing may be present in relation to the temporal synchronization, in particular the fallback state 211, the BLE time sync state 212, and the UWB time sync state 213. If a successful BLE synchronization method could not be performed before the activation of the UWB session, a transition 234 takes place from the inactive UWB session 222 to the fallback state 211 of the active UWB session 221. On the other hand, if a successful BLE synchronization method could be performed, a transition 235 takes place from the inactive UWB session 222 to the BLE time sync state 212 of the active UWB session 221.

As soon as a UWB packet is received by the responder (i.e., the vehicle 100) during the active UWB session 221, a transition 231 to the UWB time sync state 213 takes place.

As already explained, the responder of the active UWB session 221 determines a time window for receiving a UWB packet. The duration or the temporal length of this time window typically depends on the accuracy of the temporal synchronization between the initiator and the responder (and typically lies in a range around 5 ms). A low accuracy of the temporal synchronization can lead to a relatively long duration of the reception time window. A transition 232 from the BLE time sync state 212 or from the UWB time sync state 213 to the fallback state 211 can be brought about if the determined duration of the reception time window is equal to or greater than a predefined time threshold value (e.g., 30 ms).

Furthermore, a transition 233 from the active UWB session 221 to an inactive UWB session 222 can possibly be effected if a timeout of the UWB session 221 has occurred, e.g., because no UWB packet has been received by the responder for a certain period of time.

As illustrated by way of example in FIG. 1b, a plurality of devices 110 can be arranged in and/or on a vehicle 100, which can lead to a plurality of devices 110 wanting to carry out UWB-based localization of the respective device 110 at the same time. Since the frequency band for the UWB-based localization can only be used in each case by exactly one device-vehicle pairing in a particular time interval, the vehicle 100 can be enabled to perform a prioritization between the different device-vehicle pairings, in particular between the different active UWB sessions 221. The prioritization can be effected on the basis of:

the synchronization state 211, 212, 213 of the individual active UWB sessions 221;

whether a function priority for performing a particular vehicle function 103 (e.g. remote-controlled longitudinal and/or lateral guidance of the vehicle 100) is present for an active UWB session 221;

how the reception time windows for receiving a UWB packet from different active UWB sessions 221 are temporally located relative to one another; and/or

when the UWB packets are received from different active UWB sessions 221.

Thus, an apparatus 101 for a vehicle 100 is described, which apparatus is configured to manage a set of active UWB sessions 221 for a corresponding set of different devices 110 in order to effect UWB-based localization of the individual devices 110 from the set of different devices 110.

It may happen that, in a particular upcoming time interval, there is a conflict with respect to the UWB resource of the vehicle 100 between a plurality of different devices 110 or UWB sessions 221. In particular, there may be a conflict in relation to receiving a UWB packet (and subsequently sending a UWB packet in response thereto). The apparatus 101 of the vehicle 100 can be configured to bring about the following prioritization between the different devices 110 or UWB sessions 221. In particular, the UWB resource can be assigned to the device 110 or the active UWB session 221 that:

has the highest function-related priority (if any); and, if this cannot resolve the conflict (fully),

has the most precise temporal synchronization, e.g. UWB time sync state 213, before BLE time sync state 212, before fallback state 211; and, if this cannot resolve the conflict (fully), or

has the earliest start time of the reception time window for receiving a UWB packet.

If the conflict cannot be (fully) resolved by the above-mentioned prioritization criteria (in particular because all UWB sessions 221 are in the fallback state 211), the UWB resource of the vehicle 100 can be assigned to the UWB session 221 for which the UWB packet is received first.

As a result of the UWB resource being able to be assigned to only one of the plurality of UWB sessions 221, no UWB ranging procedure can be performed for the one or more other UWB sessions 221 in the particular time interval. This typically results in the one or more other UWB sessions 221, after expiry of a waiting period, starting a new attempt to perform a UWB ranging procedure with the vehicle 100.

Such prioritization between different active UWB sessions 221 can bring about robust UWB-based localization of different devices 110 in and/or on a vehicle 100.

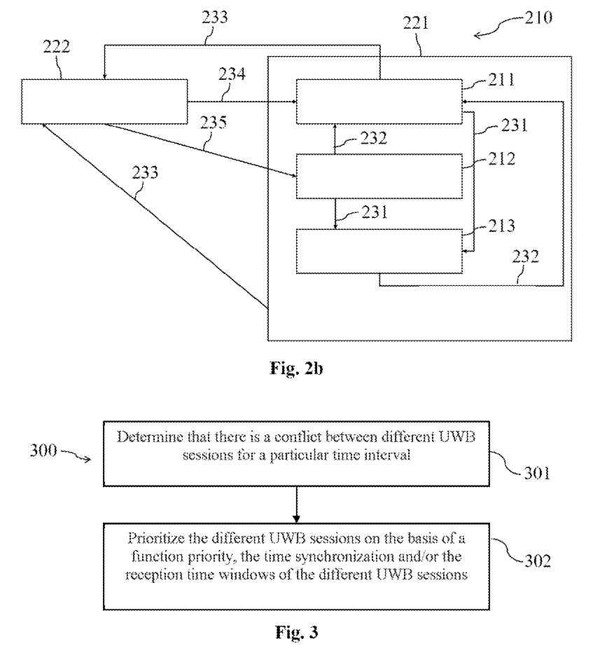

FIG. 3 shows a flowchart of an exemplary (possibly computer-implemented) method 300 for prioritizing a set of different UWB sessions 221 for performing UWB ranging procedures for a corresponding set of different devices 110 in and/or on a (motor) vehicle 100. The method 300 can be carried out by a control apparatus 101 of the vehicle 100. The set of devices 110 may include N different devices 110, e.g., N≥2 or N≥3. There may thus be N different device-vehicle pairings, for each of which there is a BLE communication connection 112. The N UWB sessions 221 may each have been activated via the respective BLE communication connection 112 (as described in this document).

The method 300 comprises determining 301 that there is a conflict (surrounding the UWB resource) between the set of different UWB sessions 221 for a particular (upcoming) time interval. A conflict can be recognized by the fact that the different UWB sessions 221 each want to use the UWB resource of the vehicle 100 to perform the UWB ranging procedure (e.g., to send a UWB packet, such as a pre-poll packet, to the vehicle 100, in particular to the communication unit 102 of the vehicle 100). The UWB resource may typically be used in each case by only precisely one UWB session 221 in a time interval.

The method 300 further comprises prioritizing 302 the different UWB sessions 221 of the set of UWB sessions in relation to the conflict on the basis of one or more prioritization criteria. In particular, a prioritized UWB session 221 can be determined from the set of UWB sessions 221 on the basis of the one or more prioritization criteria. The UWB resource may then be assigned (exclusively) to the prioritized UWB session 221.

The one or more prioritization criteria may comprise a prioritization criterion that depends on the function priority of a remote-controlled vehicle function 103 of the vehicle 100, for which a UWB session 221 from the set of UWB sessions 221 is used. One or more vehicle functions 103 which have a (particularly high) function priority may optionally be defined at the function level, for example because these one or more vehicle functions 103 are particularly relevant to safety. For example, a "remote parking" function for performing a remote-controlled parking operation of the vehicle 100 may have a function priority. The UWB session 221 used to provide such a vehicle function 103 may have an increased priority over one or more other UWB sessions 221. This makes it possible to remotely control one or more vehicle functions 103 in a particularly reliable and safe manner.

The one or more prioritization criteria may comprise a prioritization criterion that depends on the state 211, 212, 213 of the temporal synchronization of the different UWB sessions 221 of the set of UWB sessions. In this case, a UWB session 221 in the UWB time sync state 213 can be prioritized over a UWB session 221 in the BLE time sync state 212, which in turn can be prioritized over a UWB session 221 in the fallback state 211.

Furthermore, the one or more prioritization criteria may comprise a prioritization criterion that depends on the reception time windows for receiving a UWB packet from one or more UWB sessions 221 of the set of UWB sessions. In this case, the UWB session 221 with the reception time window that has the earliest start time can be prioritized.

The measures described in this document make it possible to reliably prioritize UWB sessions 221 of different electronic devices 110 in order to make it possible to robustly locate the different electronic devices 110 and to reliably remotely control vehicle functions 103 by means of the different electronic devices 110.

The present invention is not restricted to the exemplary embodiments that are shown. In particular, it should be noted that the description and the figures are intended to illustrate the principle of the proposed methods, apparatuses and systems only by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus that prioritizes a set of different UWB sessions for performing UWB ranging procedures for a corresponding set of different devices in or on a vehicle, wherein the apparatus is configured to:
determine that there is a conflict between the set of different UWB sessions for a particular time interval; and
prioritize the different UWB sessions of the set of different UWB sessions in relation to the conflict based on one or more prioritization criteria;
wherein the one or more prioritization criteria depend on:
a function priority of a remote-controlled vehicle function of the vehicle, for which a UWB session from the set of different UWB sessions is used,
a state of temporal synchronization of the different UWB sessions of the set of different UWB sessions, or
reception time windows for receiving a UWB packet from one or more UWB sessions of the set of different UWB sessions.

2. The apparatus according to claim 1, wherein the apparatus is configured to:
determine that there is a conflict surrounding a UWB resource of the vehicle between the set of different UWB sessions for the particular time interval;
determine a prioritized UWB session from the set of different UWB sessions based on the one or more prioritization criteria; and
assign the UWB resource to the prioritized UWB session in the particular time interval.

3. The apparatus according to claim 1, wherein the apparatus is configured to:
identify a first UWB session from the set of different UWB sessions that is used for the remote control of a vehicle function having a particular function priority; and
prioritize the first UWB session in relation to the conflict over one or more other UWB sessions from the set of different UWB sessions.

4. The apparatus according to claim 2, wherein the apparatus is configured to:
identify a first UWB session from the set of different UWB sessions that is used for the remote control of a vehicle function having a particular function priority; and
prioritize the first UWB session in relation to the conflict over one or more other UWB sessions from the set of different UWB sessions.

5. The apparatus according to claim 3, wherein the apparatus is configured to:
determine the state of the temporal synchronization of the first UWB session; and
prioritize the first UWB session in relation to the conflict over the one or more other UWB sessions from the set of different UWB sessions based on the state of the temporal synchronization of the first UWB session.

6. The apparatus according to claim 4, wherein the apparatus is configured to:
determine the state of the temporal synchronization of the first UWB session; and
prioritize the first UWB session in relation to the conflict over the one or more other UWB sessions from the set of different UWB sessions based on the state of the temporal synchronization of the first UWB session.

7. The apparatus according to claim 5, wherein the apparatus is configured to:
determine, as a state of the temporal synchronization of the first UWB session, whether the first UWB session has a fallback state in which there is no temporal synchronization of the first UWB session, or has a BLE time sync state or a UWB time sync state in which there is temporal synchronization of the first UWB session; and
prioritize the first UWB session in relation to the conflict over the one or more other UWB sessions from the set of different UWB sessions when the first UWB session is in the BLE time sync state or in the UWB time sync state; or
not to prioritize the first UWB session in relation to the conflict over the one or more other UWB sessions from the set of different UWB sessions when the first UWB session is in the fallback state.

8. The apparatus according to claim 6, wherein the apparatus is configured to:
determine, as a state of the temporal synchronization of the first UWB session, whether the first UWB session has a fallback state in which there is no temporal synchronization of the first UWB session, or has a BLE time sync state or a UWB time sync state in which there is temporal synchronization of the first UWB session; and
prioritize the first UWB session in relation to the conflict over the one or more other UWB sessions from the set of different UWB sessions when the first UWB session is in the BLE time sync state or in the UWB time sync state; or
not to prioritize the first UWB session in relation to the conflict over the one or more other UWB sessions from the set of different UWB sessions when the first UWB session is in the fallback state.

9. The apparatus according to claim 1, wherein the apparatus is configured to:
determine for each of the individual UWB sessions of the set of different UWB sessions whether the respective UWB session has a fallback state in which there is no temporal synchronization of the respective UWB session, or has a BLE time sync state or a UWB time sync state in which there is temporal synchronization of the respective UWB session; and
prioritize a UWB session having the BLE time sync state or the UWB time sync state in relation to the conflict over a UWB session having the fallback state.

10. The apparatus according to claim 2, wherein the apparatus is configured to:
determine for each of the individual UWB sessions of the set of different UWB sessions whether the respective UWB session has a fallback state in which there is no temporal synchronization of the respective UWB session, or has a BLE time sync state or a UWB time sync state in which there is temporal synchronization of the respective UWB session; and
prioritize a UWB session having the BLE time sync state or the UWB time sync state in relation to the conflict over a UWB session having the fallback state.

11. The apparatus according to claim 9, wherein
a UWB session changes from the fallback state or from the BLE time sync state to the UWB time sync state in response to receiving a UWB packet;
temporal synchronization in the UWB time sync state has a higher statistical accuracy than in the BLE time sync state; and
the apparatus is configured to prioritize a UWB session having the UWB time sync state in relation to the conflict over a UWB session having the BLE time sync state.

12. The apparatus according to claim 1, wherein the apparatus is configured to:
determine a time window for receiving a UWB packet within a respective UWB session for at least two UWB sessions from the set of different UWB sessions, in each of which there is temporal synchronization of the respective UWB session; and
prioritize one of the two UWB sessions in relation to the conflict over the respective other UWB session based on start times of the reception time windows.

13. The apparatus according to claim 1, wherein the apparatus is configured, when no UWB session can be prioritized based on the one or more prioritization criteria, because there is no temporal synchronization for any of the UWB sessions from the set of UWB sessions, to:
identify the temporally first UWB packet received within the particular time interval;
determine the UWB session from the set of different UWB sessions within which the identified UWB packet was sent; and
prioritize the determined UWB session in relation to the conflict over the one or more other UWB sessions from the set of UWB sessions.

14. The apparatus according to claim 1, wherein the apparatus is configured to:
perform a UWB ranging procedure within a UWB session from the set of UWB sessions,
receive a pre-poll UWB packet in the particular time interval; or
send a UWB response packet in the particular time interval.

15. The apparatus according to claim 1, wherein the apparatus is configured to sequentially:
check whether a prioritized UWB session can be identified based on a prioritization criterion that depends on a function priority of a remote-controlled vehicle function of the vehicle; and
if not, to check whether a prioritized UWB session can be identified based on a prioritization criterion that depends on the state of the temporal synchronization of the different UWB sessions; and
if not, to check whether a prioritized UWB session can be identified based on a prioritization criterion that depends on the reception time windows for receiving a UWB packet from one or more UWB sessions.

16. A method for prioritizing a set of different UWB sessions for performing UWB ranging procedures for a corresponding set of different devices in or on a vehicle, the method comprising:
determining that there is a conflict between the set of different UWB sessions for a particular time interval; and
prioritizing the different UWB sessions of the set of UWB sessions in relation to the conflict based on one or more prioritization criteria;
wherein the one or more prioritization criteria depend on:
a function priority of a remote-controlled vehicle function of the vehicle, for which a UWB session from the set of UWB sessions is used;
a state of temporal synchronization of the different UWB sessions of the set of UWB sessions; or
reception time windows for receiving a UWB packet from one or more UWB sessions of the set of UWB sessions.
